(19) United States
(12) Patent Application Publication
(10) Pub. No.: US 2009/0183570 A1
(43) Pub. Date: Jul. 23, 2009

(54) Micromachined cross-differential dual-axis accelerometer

(75) Inventors: Cenk Acar, Irvine, CA (US); Minyao Mao, Santa Rosa, CA (US)

Correspondence Address: EDWARD S. WRIGHT, 1100 ALMA STREET, SUITE 207, MENLO PARK, CA, 94025, US

(73) Assignee: CUSTOM SENSORS & TECHNOLOGIES, INC., Moorpark, CA (US)

(21) Appl. No.: 12/016,822

(22) Filed: Jan. 18, 2008

(51) Int. Cl. G01P 15/125

(52) U.S. Cl. 73/514.32

(57) ABSTRACT

Micromachined accelerometer having one or more proof masses (16, 36, 37, 71, 72) mounted on one or more decoupling frames (17, 38, 39) or on a shuttle (73) such that the proof mass(es) can move along a first (y) axis in response to acceleration along the first axis while being constrained against movement along a second (x) axis and for torsional movement about a third (z) axis perpendicular to the first and second axes in response to acceleration along the second axis. Electrodes (26, 53, 54, 78, 79) that move with the proof mass(es) are interleaved with stationary electrodes (27, 56, 57, 81, 82) to form capacitors (A-D) that change in capacitance both in response to movement of the proof mass(es) along the first axis and in response to torsional movement of the proof mass(es) about the third axis, and circuitry (31-34) connected to the electrodes for providing output signals corresponding to acceleration along the first and second axes. The capacitances of two capacitors on each side of the second axis change in the same direction in response to acceleration along the first axis and in opposite directions in response to acceleration along the second axis. Signals from the capacitors that change capacitance in opposite directions both in response to acceleration along the first axis and in response to acceleration along the second axis are differentially combined to provide first and second difference signals, and the difference signals are additively and differentially combined to provide output signals corresponding to acceleration along the first and second axes.

### BACKGROUND OF THE INVENTION

1. Field of Invention

This invention pertains generally to inertial measurement systems and, more particularly, to a micromachined dual-axis accelerometer.

2. Related Art

One of the major challenges in the design of low-cost micromachined multi-axis accelerometers is minimizing the die size while maintaining high sensitivity. In most of the existing multi-axis accelerometers, separate proof masses with separate suspension beams and detection electrodes are utilized. Even though this allows the response due to acceleration along each axis to be isolated, duplicating the number of masses, electrodes and bonding areas is a major cost factor.

### SUMMARY OF THE INVENTION

A micromachined dual-axis accelerometer has one or more proof masses and frames suspended above a substrate in a manner permitting movement of the proof mass(es) relative to the substrate along the first axis in response to acceleration along the first axis and also permitting torsional movement of the proof mass(es) relative to the substrate about a third axis perpendicular to the first and second axes in response to acceleration along the second axis, detection electrodes that move with the proof mass(es) relative to stationary electrodes to form a plurality of capacitors each of which changes in capacitance both in response to movement of the proof mass along the first axis and in response to torsional movement of the proof mass(es) about the third axis, and circuitry connected to the electrodes for providing output signals corresponding to acceleration along the first and second axes.

### BRIEF DESCRIPTION OF THE DRAWINGS

FIG. 1 is a top plan view of one embodiment of a dual-axis micromachined accelerometer according to the invention.

FIG. 2 is an enlarged, fragmentary top plan view of a portion of the accelerometer in the embodiment of FIG. 1.

FIG. 3 is an isometric view of the moving structure of the accelerometer in the embodiment of FIG. 1.

FIGS. 4 and 5 are operational top plan views of the embodiment of FIG. 1 illustrating, in exaggerated form, movement of the proof mass in response to acceleration along first and second axes.

FIG. 6 is a block diagram of the embodiment of FIG. 1 with cross-differential circuitry for providing output signals corresponding to acceleration along the first and second axes.

FIG. 7 is a top plan view of another embodiment of a dual-axis micromachined accelerometer according to the invention.

FIGS. 8 and 9 are operational views of the embodiment of FIG. 7 illustrating, in exaggerated form, movement of the proof mass in response to acceleration along first and second axes.

FIG. 10 is a top plan view of another embodiment of a dual-axis micromachined accelerometer according to the invention.

FIG. 11 is a fragmentary view of the accelerometer in the embodiment of FIG. 10.

FIG. 12 is a top plan view of another embodiment of a dual-axis micromachined accelerometer according to the invention.

FIGS. 13 and 14 are operational views of the embodiment of FIG. 12 illustrating, in exaggerated form, movement of the proof mass in response to acceleration along first and second axes.

### DETAILED DESCRIPTION

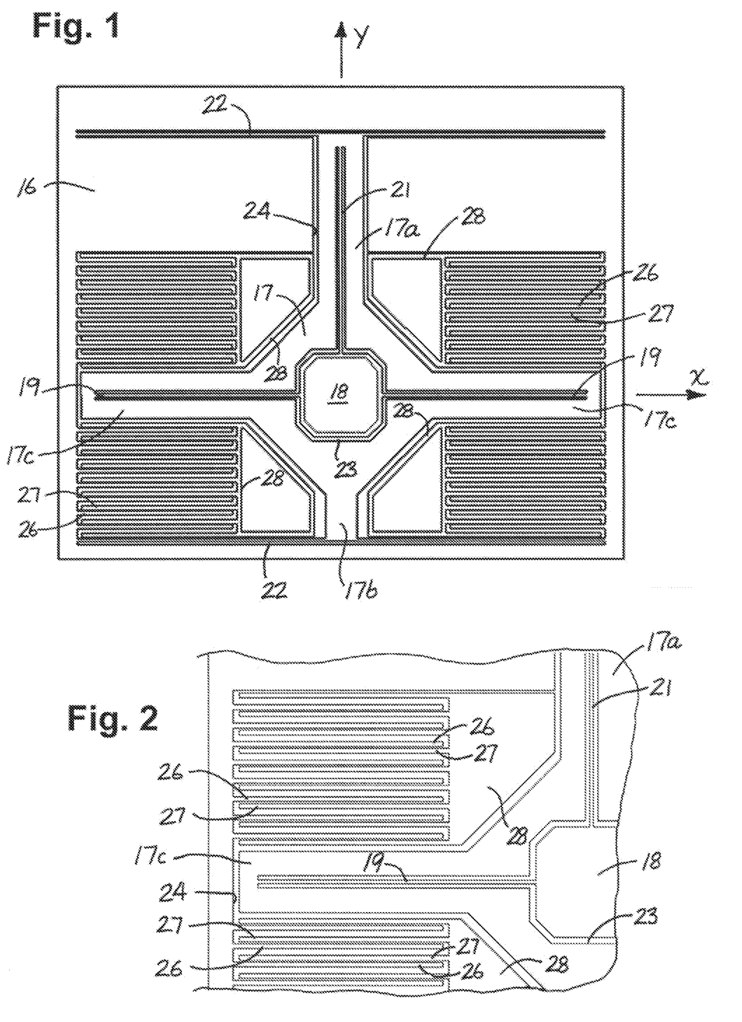

In the embodiment of FIGS. 1-6, the accelerometer has a single proof mass 16 suspended above a substrate for monitoring acceleration along mutually perpendicular x- and y-axes that lie in a plane parallel to the substrate.

The suspension for the proof mass includes a decoupling frame 17 which is suspended from a post 18 by flexible beams 19, 21 that extend along the x- and y-axes, respectively. The post is anchored to the substrate, and the beams prevent the decoupling frame from moving along the x- and y-axes while permitting it to rotate or move torsionally about a third axis (the z-axis) perpendicular to the x- and y-axes. The beams are relatively rigid in the z direction and prevent out-of-plane movement of the frame. Thus, the frame is constrained for torsional in-plane movement about the z-axis, with linear and torsional motion along and about other axes being suppressed.

The proof mass is suspended from the decoupling frame by flexible beams 22, 22 which extend in a direction parallel to the x-axis and perpendicular to the y-axis. These beams are relatively flexible in the y-direction and relatively stiff in the x and z directions. Thus, they permit movement of the proof mass relative to the decoupling frame along the y-axis and constrain the proof mass and the frame for torsional movement together about the z-axis. They also prevent movement of the proof mass along the x-axis as well as preventing out-of-plane movement of the mass.

The proof mass is thus constrained to torsional motion about the z-axis and linear motion along the y-axis in a manner which minimizes cross-axis sensitivity and allows separation of undesired structural modes from the operational modes.

The moving structure is anchored from the inside, with post 18 being disposed in a central opening 23 in decoupling frame 17, and the decoupling frame being disposed in an opening 24 in proof mass 16. Mounting the moving structure in this manner helps to minimize the effects of thermal and packaging stresses.

Decoupling frame 17 has the shape of a cross with long and short arms 17a, 17b extending along the y-axis on opposite sides of post 18, and arms 17c, 17c extending along the x-axis on opposite sides of the post. Arms 17a and 17c are substantially equal in length, as are the flexible beams 19, 21 that suspend the frame from the post. Those beams extend between the post and the outer end portions of the arms, and the flexible beams 22, 22 that suspend proof mass 16 from the decoupling frame are connected to the outer end of long arm 17a and short arm 17b.

The mass of proof mass 16 is distributed symmetrically of the y-axis but asymmetrically of the x-axis, with the portion of the mass above the x-axis being substantially greater than the portion below it. The asymmetry about the x-axis causes the proof mass to rotate about the z-axis in response to acceleration along the x-axis, but not in response to acceleration along the y-axis. Thus, the proof mass moves linearly along the y-axis in response to acceleration along the y-axis and torsionally about the z-axis in response to acceleration along the x-axis.

Both the linear motion of the proof mass along the y-axis and the torsional motion about the z-axis are monitored with a single set of capacitors formed by detection electrodes 26 and stationary electrodes 27. Electrodes 26 are affixed to the proof mass and move with it, whereas electrodes 27 are affixed to anchors 28 on the substrate. The electrodes extend in a direction parallel to the x-axis and perpendicular to the y-axis and are interleaved to form capacitors A-D in the four quadrants of the coordinate system defined by those axes.

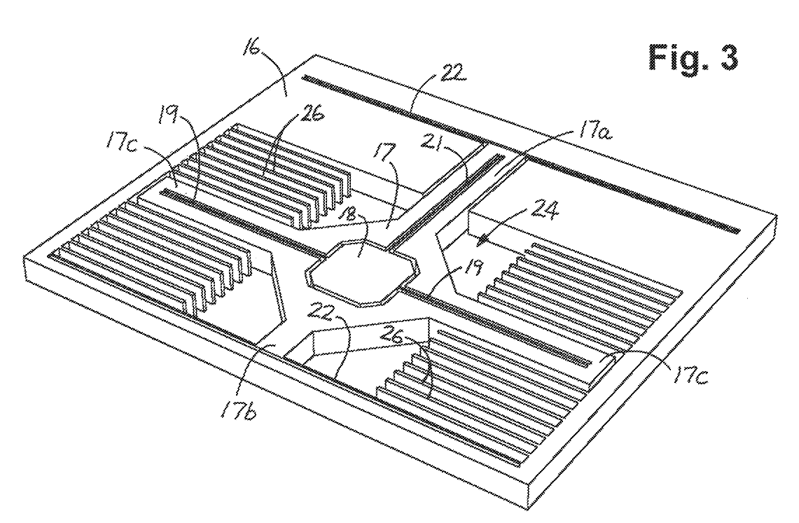

As best seen in FIG. 2, in the two capacitors above the x-axis (A and C), the movable electrodes 26 are positioned above the corresponding stationary electrodes 27, and in the two capacitors below the x-axis (B and D), the movable electrodes 26 are below the corresponding stationary electrodes 27. Thus, movement of proof mass 16 in a negative x-direction decreases the spacing between the plates of capacitors A and C, thereby increasing the capacitance of those capacitors, whereas it increases the spacing between the plates of capacitors B and D and thereby decreases the capacitance of those capacitors.

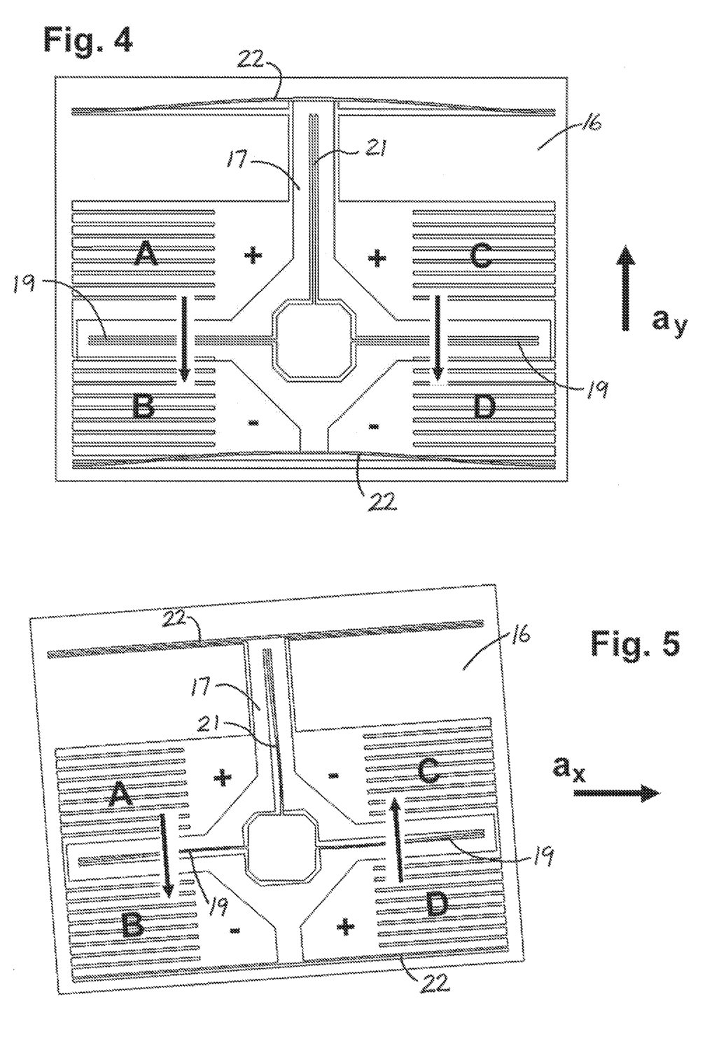

As illustrated in FIG. 4, acceleration in the positive y-direction causes proof mass 16 to move downwardly in the negative y-direction relative to post 18 and the rest of the stationary structure, thereby increasing the capacitance of capacitors A and C and decreasing the capacitance of capacitors B and D. As illustrated in FIG. 5, acceleration in the positive x-direction causes the proof mass to rotate in a counter-clockwise direction, thereby increasing the capacitance of capacitors A and D and decreasing the capacitance of capacitors B and C. Thus, with acceleration along the y-axis, the capacitances of the two capacitors on each side of x-axis both change in the same direction, and with acceleration along the x-axis, they change in opposite directions. However, both for acceleration along the x-axis and for acceleration along the y-axis, the capacitances of the two capacitors on opposite sides of the y-axis change in opposite directions.

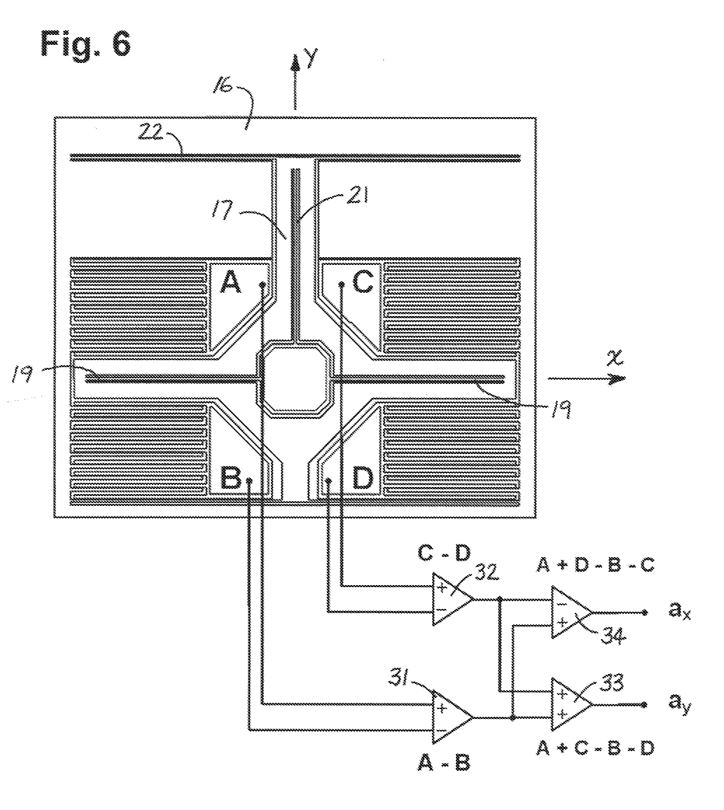

A cross-differential circuit for providing output signals corresponding to acceleration along the x- and y-axes is illustrated in FIG. 6. This circuit includes an input stage comprising a pair of subtraction circuits 31, 32 to which signals corresponding to capacitances of the four capacitors are applied. Since capacitors A and B change in opposite directions both for x-axis acceleration and for y-axis acceleration and capacitors C and D also change in opposite directions for acceleration along the two axes, an (A−B) signal is obtained by differential capacitive detection of the A and B electrodes, and a (C−D) signal is obtained by differential capacitive detection of the C and D electrodes. For this purpose, the A and C signals are applied to the positive inputs of the two subtraction circuits, and the B and D signals are applied to the negative inputs.

The output of subtraction circuit 31 is applied to one input of an adder 33 and to the positive input of another subtraction circuit 34, and the output of subtraction circuit 32 is applied to a second input of the adder and to the negative input of subtraction circuit 34.

For y-axis acceleration, the (A−B) and (C−D) signals change in the same direction, and an output signal corresponding the y-axis acceleration is obtained by summing the (A−B) and (C−D) signals in adder 33, yielding

a_{y}=(A−B)+(C−D)=A+C−B−D.

For x-axis acceleration, the (A−B) and (C−D) signals change in opposite directions, and an output signal corresponding the x-axis acceleration is obtained by differentially combining the (A−B) and (C−D) signals in another subtraction circuit 34, yielding

aₓ=(A−B)−(C−D)=A+D−B−C.

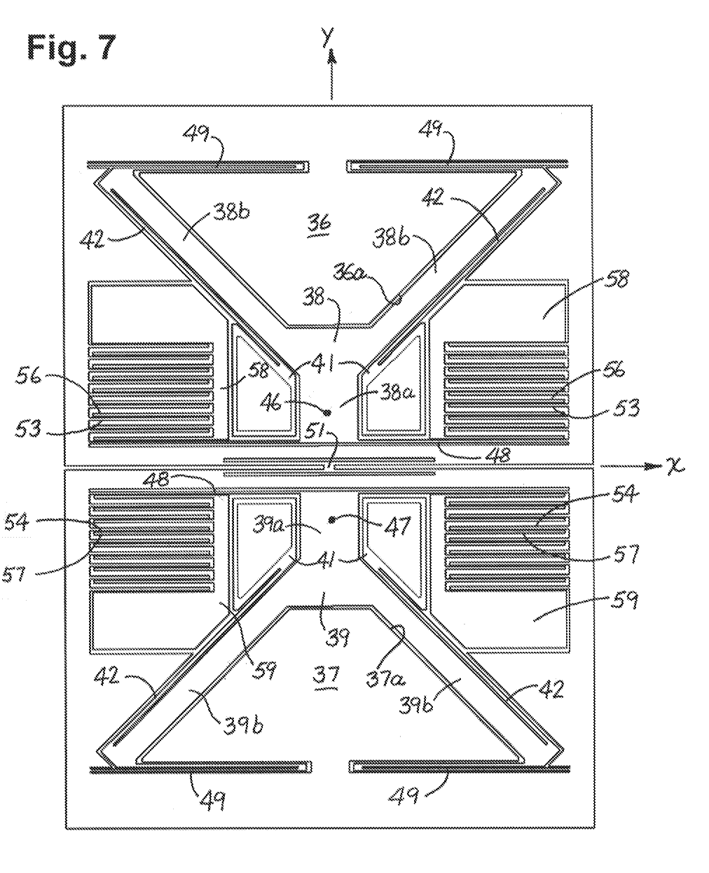

In the embodiment of FIG. 7, the accelerometer has two proof masses 36, 37 mounted on decoupling frames 38, 39 on opposite sides of the x-axis. As in the embodiment of FIG. 1, the decoupling frames are constrained for movement only about the z-axis, and the proof masses are mounted on the decoupling frames in a manner permitting them to move along the y-axis while constraining each proof mass and its associated decoupling frame for torsional movement together about a z-axis.

Decoupling frames 38, 39 are suspended from anchors 41 by flexible beams 42 which constrain the frames for torsional in-plane movement about the z-axes, with linear and torsional motion along and about other axes being suppressed. In this embodiment, the decoupling frames are generally Y-shaped, with inner arms 38a, 39a extending along the y-axis and outer arms 38b, 39b extending from the inner arms at angles on the order of 45 degrees to the y-axis. Beams 42 extend between anchors 41 and the outer end portions of arms 38b, 39b along mutually perpendicular axes that converge at the z axes or centers of rotation 46, 47. The beam axes are inclined at angles of 45 degrees to the x- and y-axes, and the centers of rotation lie on the y-axis. By moving the beams farther apart, the centers of rotation can be shifted to the intersection of the x- and y-axes, in which case both masses will rotate about the same z-axis.

Proof masses 36, 37 are suspended from decoupling frames 43, 44 by flexible beams 48 connected to the inner ends of arms 38a, 39a, and by folded flexible beams 49 connected to the outer end portions of arms 38b, 39b. These beams extend in a direction parallel to the x-axis and perpendicular to the y-axis, and are relatively flexible in the y-direction and relatively stiff in the x and z directions. Thus, they permit movement of the proof masses relative to the decoupling frames along the y-axis and constrain the proof masses and the frames for torsional movement together about the z-axes. They also prevent movement of the proof masses along the x-axis as well as preventing out-of-plane movement of the masses.

The decoupling frames and the beams which support them are located in openings 36a, 37a in the proof masses, and with the anchors 41 for the beams being positioned close to the intersection of the x- and y-axes, the moving structure is again anchored near its center.

Adjacent edge portions of proof masses 36, 37 are connected together by a coupling link 51 which is relatively rigid in the x-direction and flexible in the y-direction. This link constrains the two masses for equal and opposite rotation about the z-axes and prevents them from rotating in the same direction as they might otherwise tend to do if the device were to rotate about one of the z-axes or another axis perpendicular to the plane of the device. This prevents angular z-axis acceleration from exciting the x-axis acceleration mode of the device. Even though the effect of this particular form of cross-axis excitation is negligible for most applications, it is eliminated completely by the coupling link.

As in the embodiment of FIG. 1, both the linear motion of the proof masses along the y-axis and the torsional motion about the z-axes are monitored with a single set of capacitors formed by detection electrodes which move with the masses and stationary electrodes which are anchored to the substrate. In this embodiment, detection electrodes 53, 54 extend from proof masses 36, 37 and are interleaved with stationary electrodes 56, 57 which extend from anchors 58, 59 on opposite sides of the x-axis. The electrodes extend in a direction parallel to the x-axis and perpendicular to the y-axis and form capacitors A-D in the four quadrants of the coordinate system defined by those axes.

The electrodes 53 affixed to proof mass 36 are positioned below the corresponding stationary electrodes 56, and the electrodes 54 affixed to proof mass 37 are positioned above the corresponding stationary electrodes 57. Thus, capacitors A and C decrease in capacitance and capacitors B and D increase in capacitance when the proof masses move downwardly in a negative y-direction.

Although the two proof masses are identical and are disposed symmetrically of both the x- and y-axes, each of the masses is disposed entirely on one side of the x-axis, and consequently acceleration along the x-axis causes the two masses to rotate about the z-axes.

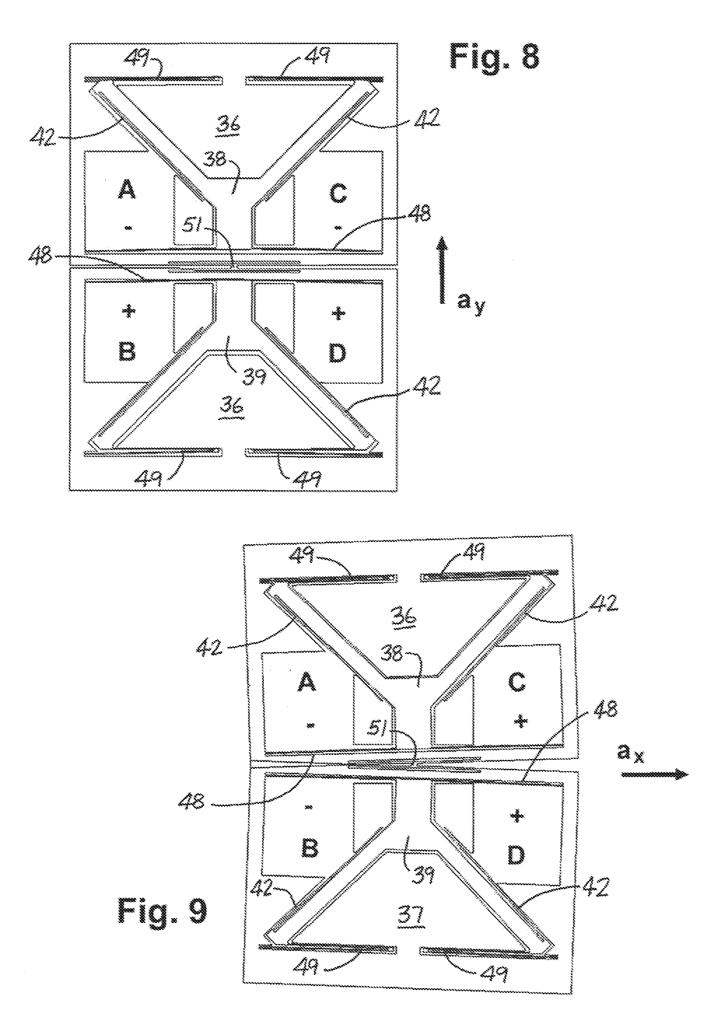

As illustrated in FIG. 8, acceleration in the positive y-direction causes proof masses 36, 37 to move in the negative y-direction, thereby decreasing the capacitance of capacitors A and C and increasing the capacitance of capacitors B and D.

As illustrated in FIG. 9, acceleration in the positive x-direction causes proof mass 36 to rotate in a counter-clockwise direction and proof mass 47 to rotate in a clockwise direction, thereby decreasing the capacitance of capacitor A and increasing the capacitance of capacitor C while decreasing the capacitance of capacitor B and increasing the capacitance of capacitor D.

The changes in capacitance are monitored with a circuit similar to that shown in FIG. 6 to provide output signals corresponding to acceleration along the x- and y-axes. In this embodiment, however, since the capacitances which change in opposite directions both for x-axis acceleration and for y-axis acceleration are capacitors A and D and capacitors B and C, the A and D signals are applied to the positive and negative inputs of subtraction circuit 31 to provide a (D−A) signal, and the B and C signals are applied to the positive and negative inputs of subtraction circuit 32 to provide a (C−B) signal.

For y-axis acceleration, the (D−A) and (C−B) signals change in opposite directions, and an output signal corresponding the y-axis acceleration is obtained by differentially combining the (D−A) and (C−B) signals in subtraction circuit 34, yielding

a_{y}=(D−A)−(C−B)=B+D−A−C.

For x-axis acceleration, the (D−A) and (C−B) signals change in the same direction, and an output signal corresponding the x-axis acceleration is obtained by summing the (D−A) and (C−B) signals in adder 33, yielding

aₓ=(D−A)+(C−B)=C+D−A−B.

As noted above, the connection between the adjacent edge portions of the two proof masses constrains the two masses for rotation in opposite directions and prevents angular z-axis acceleration from exciting the x-axis acceleration mode of the device.

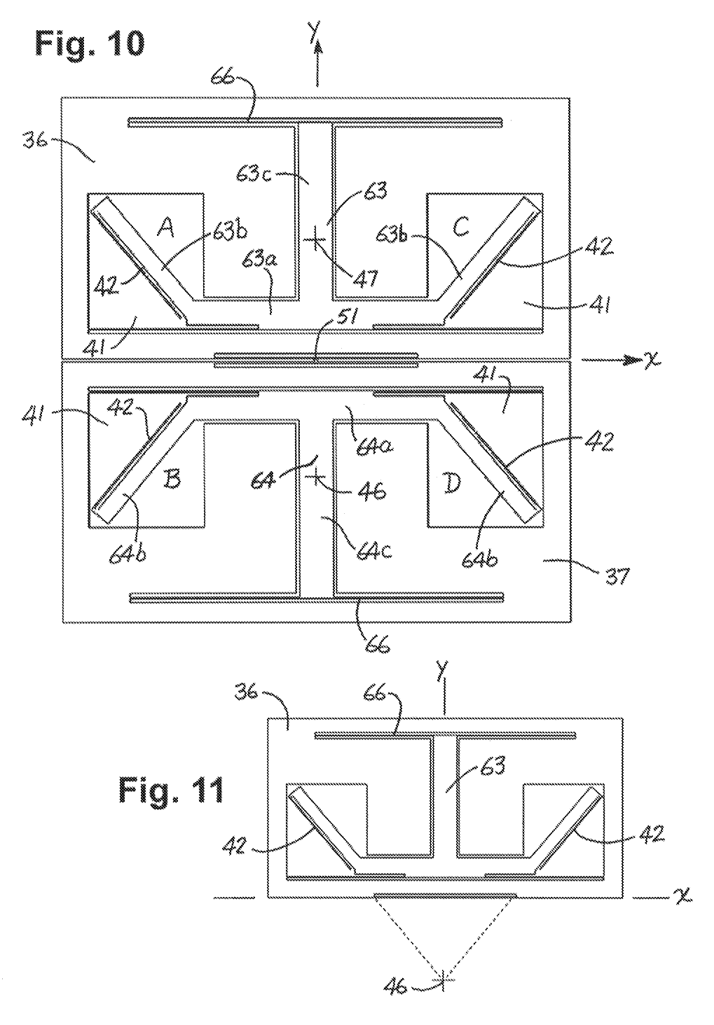

With the beams that support the decoupling frames extending obliquely of the x- and y-axes, the sensitivity of the accelerometer can be increased by moving the beams farther apart and thereby shifting the z-axes, or centers of rotation, farther from the centers of the masses. An embodiment incorporating this feature is illustrated in FIG. 10.

The embodiment of FIG. 10 is generally similar to the embodiment of FIG. 7, and like reference numerals designate corresponding elements in the two. In the embodiment of FIG. 10, however, decoupling frames 63, 64 have elongated inner arms 63a, 64a which extend in the x-direction on opposite sides of the x-axis, with arms 63b, 64b extending obliquely from the outer ends of the inner arms at angles on the order of 45 degrees to the x- and y-axes.

Anchors 41 are spaced well away from the y-axis, near the lateral margins of the proof masses, and relatively close to the x-axis. Beams 42 extend between the inner portions of the anchors and the outer end portions of arms 63b, 64b at angles on the order of 45 degrees to the x- and y-axes.

The decoupling frames also have elongated central arms 63c, 64c that extend outwardly from inner arms 63a, 64a along the y-axis, and proof masses 36, 37 are suspended from the frames by flexible beams 66 that are connected to the outer ends of the central arms. Those beams are perpendicular to the y-axis and parallel to the x-axis and are flexible only in the y-direction.

As in the embodiment of FIG. 7, coupling link 51 constrains the two proof masses for rotation in opposite directions, and electrodes affixed to the proof masses are interleaved with stationary electrodes to form capacitors A, B, C, and D in the four quadrants defined by the x- and y-axes.

As illustrated in FIGS. 10 and 11, the z-axes or centers of rotation 46, 47 at which the axes of beams 42 converge are located on the opposite sides of the x-axes from the masses. With the centers of rotation farther from the masses and the capacitor plates or electrodes affixed thereto, a given acceleration produces greater movement of the masses and electrodes, thereby providing greater changes in capacitance and, hence, greater sensitivity.

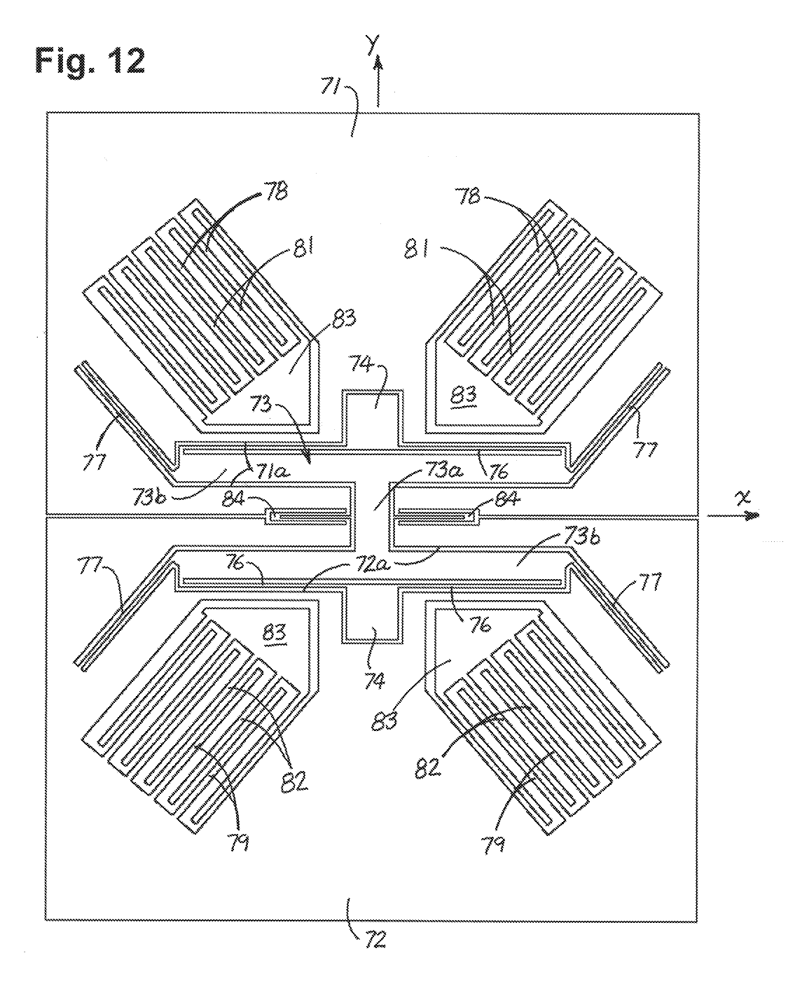

In the embodiment of FIG. 12, proof masses 71, 72 are mounted to a common shuttle, or frame, 73 in a manner that prevents relative linear displacement of the two masses. The shuttle is generally H-shaped, with a cross arm 73a extending along the y-axis and a pair of side arms 73b on opposite sides of the x-axis. The shuttle is suspended from anchor posts 74 by flexible beams 76 that extend in a direction parallel to the x-axis between the posts and the outer end portions of side arms 73b. These beams are relatively flexible in the y-direction and relatively rigid in the x- and z-directions, and they constrain the shuttle for movement along the y-axis but not along the x-axis or about axes perpendicular to the x- and y-axes.

Proof masses 71, 72 are mounted to the shuttle by mutually perpendicular flexible beams 77 that extend between the outer end portions of arms 73b shuttle and the proof masses at angles on the order of 45 degrees to the x- and y-axes. These beams constrain the proof masses and the shuttle for movement together along the y-axis while preventing movement of the proof masses along the x-axis and permitting torsional movement of the proof masses about the z-axes.

Detection electrodes 78, 79 extend from proof masses 71, 72 and are interleaved with stationary electrodes 81, 82 affixed to anchors 83 to form capacitors A, B, C, and D in the four quadrants defined by the x- and y-axes. These electrodes extend at angles on the order of 45 degrees to the x- and y-axes, with moving electrodes 78 being positioned above the corresponding stationary electrodes 81, and moving electrodes 79 being positioned below the corresponding stationary electrodes 82.

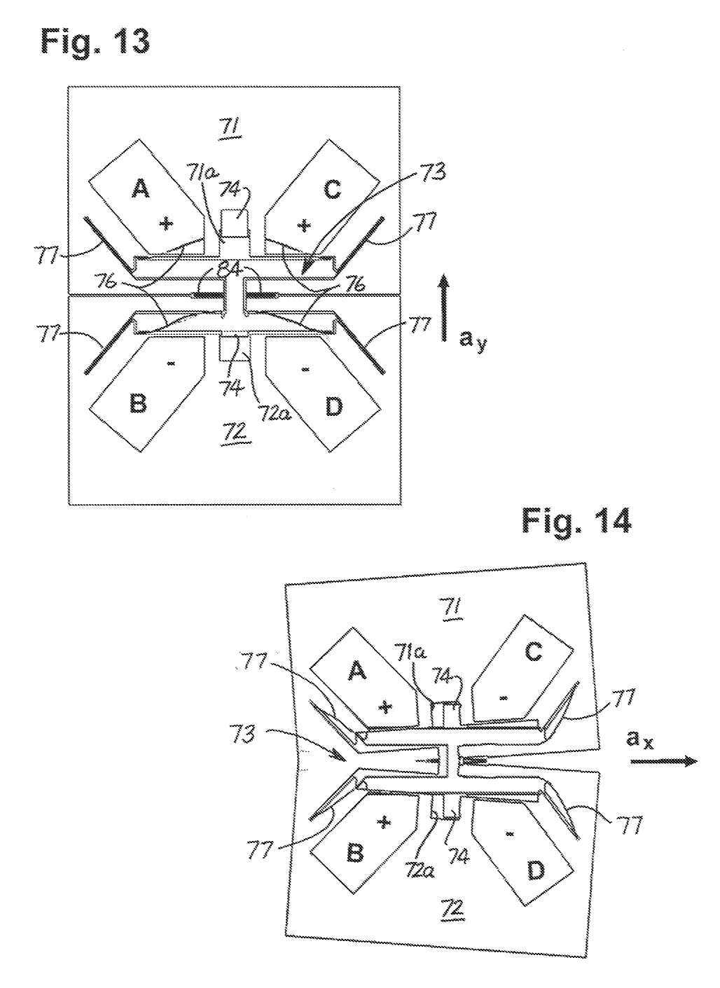

As illustrated in FIG. 13, acceleration in the shuttle deflection direction, the positive y-direction in this example, causes the shuttle and the proof masses to move together in the negative y-direction relative to anchor posts 74 and the rest of the stationary structure, thereby increasing the capacitance of capacitors A and C and decreasing the capacitance of capacitors B and D.

When acceleration occurs in the orthogonal direction, i.e. the x-direction, the shuttle remains stationary, and the proof masses deflect torsionally in opposite directions about the z-axes. Thus, as shown in FIG. 14, acceleration in the positive x-direction causes proof mass 71 to rotate in the counter-clockwise direction and proof mass 72 to rotate in the clockwise direction, thereby increasing the capacitance of capacitors A and B and decreasing the capacitance of capacitors C and D.

Signals corresponding to the changes in capacitances are processed in circuitry similar to that shown in the embodiment of FIG. 6 to provide output signals corresponding to acceleration along the x- and y-axes.

The shuttle is disposed in openings 71a, 72a in the proof masses, and adjacent edge portions of the two proof masses are connected together by folded coupling links 84, 84 on opposite sides of cross arm 73a. As in the previous embodiments, those links constrain the two masses for rotation in opposite directions about the z-axes.

With the two proof masses connected to the common shuttle by torsional suspension beams 77, the two masses cannot move relative to the shuttle or to each other in either the x-direction or the y-direction. Thus, the masses and the shuttle move together in the shuttle deflection direction, and in the orthogonal direction, the masses deflect torsionally in opposite directions, and the shuttle remains stationary.

The invention has a number of important features and advantages. Utilizing a single proof mass and the same set of electrodes for sensing acceleration along two axes in a cross-differential mode makes it possible to achieve maximum sensitivity and performance with minimal die area. Even in the embodiments with two proof masses, the chip area dedicated to capacitive detection electrodes is still utilized for both sensing axes, thereby maintaining the ability to achieve maximum sensitivity and performance with minimal die area. In addition, utilizing the same set of detection electrodes for the two sensing axes may also make it possible to simplify the circuitry for processing signals from the device.

The decoupling frames isolate the motion of the proof masses in response to acceleration along each of the two sensing axes, thereby minimizing cross-axis sensitivity. Relative linear motion of the masses is suppressed by the common shuttle, and with the adjacent edge portions of the two masses connected together, the two masses are constrained for rotation only in opposite directions. Thus, angular acceleration about the z-axis cannot excite the x-axis acceleration detection mode.

The motion of the proof masses is constrained by the suspension systems to the two operational modes, i.e. torsional motion about the z-axis and linear motion along the y-axis. This makes it possible to separate undesired modes of the structure from the operational modes.

Anchoring the moving structure at its center minimizes the effects of thermal and packaging stresses, and locating the centers of rotation further from the masses improves the sensitivity of the torsional system.

It is apparent from the foregoing that a new and improved micromachined dual-axis accelerometer has been provided. While only certain presently preferred embodiments have been described in detail, as will be apparent to those familiar with the art, certain changes and modifications can be made without departing from the scope of the invention as defined by the following claims.

1. A micromachined accelerometer for sensing acceleration along first and second axes, comprising: at least one proof mass and one frame suspended above a substrate in a manner permitting movement of each proof mass relative to the substrate along the first axis in response to acceleration along the first axis and also permitting torsional movement of each proof mass relative to the substrate about a third axis perpendicular to the first and second axes in response to acceleration along the second axis, detection electrodes that move with each proof mass relative to stationary electrodes to form a plurality of capacitors each of which changes in capacitance both in response to movement of a proof mass along the first axis and in response to torsional movement of a proof mass about the third axis, and circuitry connected to the electrodes for providing output signals corresponding to acceleration along the first and second axes.

2. The accelerometer of claim 1 wherein the detection electrodes extend from each proof mass and are interleaved with the stationary electrodes.

3. The accelerometer of claim 1 wherein the detection electrodes are positioned on one side of the stationary electrodes on one side of the second axis and on the opposite side of the stationary electrodes on the other side of the second axis.

4. The accelerometer of claim 1 wherein the electrodes form capacitors in the four quadrants defined by the first and second axes, with the capacitances of the two capacitors on each side of the second axis changing in the same direction in response to acceleration along the first axis and in opposite directions in response to acceleration along the second axis.

5. The accelerometer of claim 4 wherein the circuitry includes means for differentially combining signals from capacitors that change capacitance in opposite directions both in response to acceleration along the first axis and in response to acceleration along the second axis to provide first and second difference signals, means for additively combining the difference signals to provide an output signal corresponding to acceleration along one of the axes, and means for differentially combining the difference signals to provide an output signal corresponding to acceleration along the other axis.

6. The accelerometer of claim 1 wherein the frame is suspended from the substrate by a first pair of flexible beams, and the proof mass is suspended from the frame by a second pair of flexible beams, with the beams in one of the pairs extending along axes that converge at a center of rotation on the side of the second axis opposite the proof mass.

7. The accelerometer of claim 1 having proof masses on opposite sides of the second axis, with adjacent portions of the proof masses being connected together to prevent the proof masses from moving torsionally in the same direction about the third axes in response to rotation of the accelerometer about the third axis.

8. The accelerometer of claim 1 having a single proof mass and a single frame, with the frame being suspended in a manner preventing movement of the frame along the first and second axes while permitting torsional movement of the frame about the third axis, and the proof mass having a mass distributed asymmetrically of the second axis and being mounted on the frame in a manner permitting movement of the proof mass along the first axis in response to acceleration along the first axis and constraining the proof mass and the frame for torsional movement together about the third axis in response to acceleration along the second axis.

9. The accelerometer of claim 8 wherein the frame is mounted on flexible beams that extend along the first and second axes, the proof mass is suspended from the frame by flexible beams that extend in a direction parallel to the second axis, and the electrodes extend in a direction perpendicular to the first axis.

10. The accelerometer of claim 8 wherein the frame is suspended from an anchor disposed in a central opening in the frame, and the frame is disposed in an opening in the proof mass.

11. The accelerometer of claim 10 wherein the frame has the shape of a cross with long and short arms extending along the first axis on opposite sides of the anchor and arms of equal length extending along the second axis on opposite sides of the anchor, with flexible suspension beams extending between the anchor and outer end portions of the long arm and the arms of equal length, and flexible suspension beams extending between the proof mass and the outer end portions of the long arm and the short arm.

12. The accelerometer of claim 1 having first and second decoupling frames mounted in a manner preventing movement of the frames along the first and second axes while permitting torsional movement of the frames about third axes perpendicular to the first and second axes, and first and second proof masses mounted on respective ones of the frames in a manner permitting movement of the proof masses along the first axis in response to acceleration along the first axis and constraining the respective proof masses and frames for torsional movement together about a third axis in response to acceleration along the second axis.

13. The accelerometer of claim 12 wherein the decoupling frames are mounted on flexible beams that extend along axes that are inclined at angles to the first and second axes, and the proof masses are suspended from the decoupling frames by flexible beams that extend in a direction parallel to the second axis.

14. The accelerometer of claim 13 wherein the decoupling frames are disposed in openings in the proof masses and are generally Y-shaped, with inner arms extending along the first axis and outer arms extending at angles to the first axis.

15. The accelerometer of claim 12 wherein each of the decoupling frames is mounted on flexible beams extending along axes that converge at a center of rotation on the opposite side of the second axis from the mass suspended from the frame.

16. The accelerometer of claim 1 wherein the frame comprises a shuttle mounted in a manner permitting movement of the shuttle along the first axis but preventing movement of the shuttle along the second axis and about third axes perpendicular to the first and second axes, and proof masses are mounted to the shuttle on opposite sides of the second axis in a manner permitting torsional movement of the proof masses about the third axes while constraining the proof masses and the shuttle for movement together along the first axis and preventing movement of the proof masses relative to the shuttle along the second axis.

17. The accelerometer of claim 16 wherein the shuttle is suspended by flexible beams that extend in a direction perpendicular to the first axis, the proof masses are mounted to the shuttle by flexible beams which extend along axes that are oblique to the first and second axes, and the electrodes extend in directions parallel to the axes of the flexible beams that mount the proof masses to the shuttle.

18. The accelerometer of claim 16 wherein the shuttle is disposed in openings in the proof masses and is generally H-shaped, with a cross arm extending along the first axis and side arms parallel to the second axis on opposite sides of the second axis.

19. A micromachined accelerometer for sensing acceleration along first and second axes, comprising:
at least one proof mass and one frame suspended above a substrate in a manner permitting movement of each proof mass relative to the substrate along the first axis in response to acceleration along the first axis and also permitting torsional movement of each proof mass relative to the substrate about a third axis perpendicular to the first and second axes in response to acceleration along the second axis,
detection electrodes that move with each proof mass relative to stationary electrodes to form capacitors in the four quadrants defined by the first and second axes, with the capacitances of the two capacitors changing in the same direction in response to acceleration along the first axis and in opposite directions in response to acceleration along the second axis, and
circuitry for differentially combining signals from capacitors that change capacitance in opposite directions both in response to acceleration along the first axis and in response to acceleration along the second axis to provide first and second difference signals, additively combining the difference signals to provide an output signal corresponding to acceleration along one of the axes, and differentially combining the difference signals to provide an output signal corresponding to acceleration along the other axis.
